(19) United States
(12) Patent Application Publication
(10) Pub. No.: US 2020/0372485 A1
(43) Pub. Date: Nov. 26, 2020

(54) METHOD FOR SHARING, COLLECTING AND PROCESSING DATA AND RELATED SYSTEM

(71) Applicant: Simone BORRELLI, Napoli (IT)

(72) Inventor: Simone BORRELLI, Napoli (IT)

(21) Appl. No.: 16/958,235

(22) PCT Filed: Dec. 13, 2018
(86) PCT No.: PCT/IT2018/000159

§ 371 Date: Jun. 26, 2020

(30) Foreign Application Priority Data
Dec. 28, 2017 (IT) 102017000150354

(51) Int. Cl. G06Q 20/14; G07C 9/20; G07C 9/27

(52) U.S. Cl. CPC G06Q 20/145; G07C 9/27; G07C 9/215

(57) ABSTRACT

A method is described for sharing, collecting and processing data designed to allow at least one user to locate a plurality of structures, to exploit at least one service provided by a plurality of structures and to pay by the user depending on the actual usage time of the service by the user.

### CROSS-REFERENCE TO RELATED APPLICATIONS

This application claims priority under 35 U.S.C. § 371 to the International Application No. PCT/IT2018/000159, filed Dec. 13, 2018, and to the Italian Application No. 10 2017 000 150354, filed Dec. 28, 2017, now pending, the contents of which are hereby incorporated by reference.

### DESCRIPTION

The present disclosure refers to a method for sharing, collecting and processing data designed to allow a user to locate and use dedicated structuresd to sports and well-being activities, in particular to a timed method.

Methods for sharing, collecting and processing data which allow a user, through a software application, to locate, choose and access a structure dedicated to sports and well-being activities are not known in the art.

Object of the present disclosure is solving the above prior art problems by providing a method for sharing, collecting and processing data designed to allow a user to access to a plurality of structures providing sports activities and physical well-being, allowing to pay by a user of the services provided by the dedicated structures depending on the actual usage time of the services.

Another object is providing a method capable of allowing a user to choose the use of a plurality of services provided by a structure dedicated to sports activities and to the physical well-being depending on the location of the dedicated structure through a software application.

The above and other objects and advantages of the disclosure, as will result from the following description are obtained with a data sharing, collecting and processing method as claimed in claim 1. Preferred embodiments and non-trivial variations of the present disclosure are the subject matter of the dependent claims.

It is intended that all enclosed claims are an integral part of the present description.

It will be immediately obvious that numerous variations and modifications (for example related to shape, sizes, arrangements and parts with equivalent functionality) can be made to what is described, without departing from the scope of the disclosure as appears from the enclosed claims.

The present disclosure will be better described by some preferred embodiments thereof, provided as a non-limiting example, with reference to the enclosed drawings, in which:

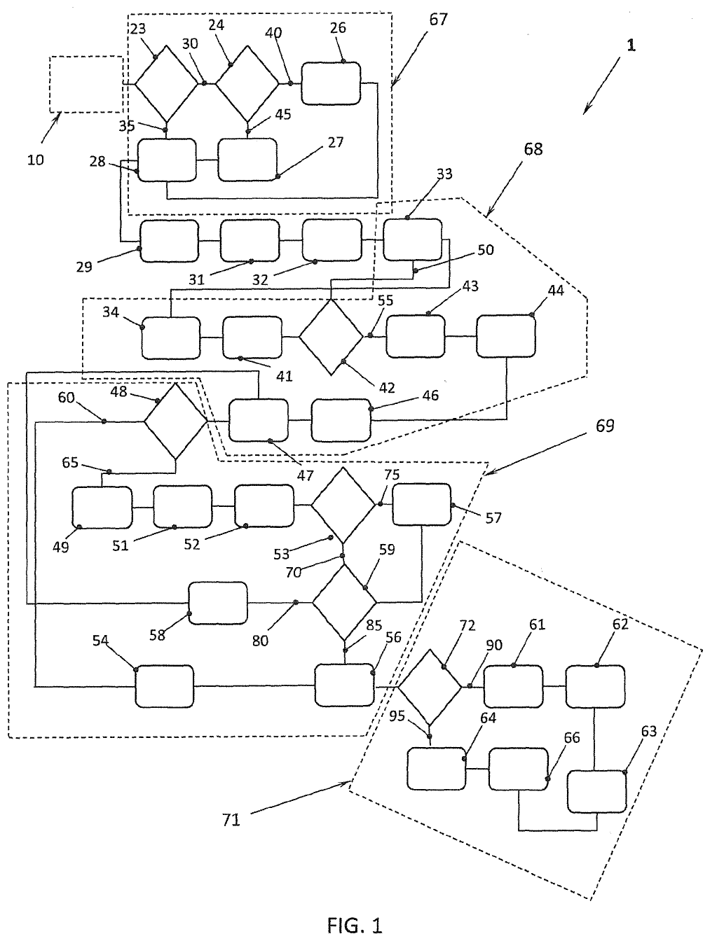

FIG. 1 shows a block diagram of an embodiment of the method according to the present disclosure; and

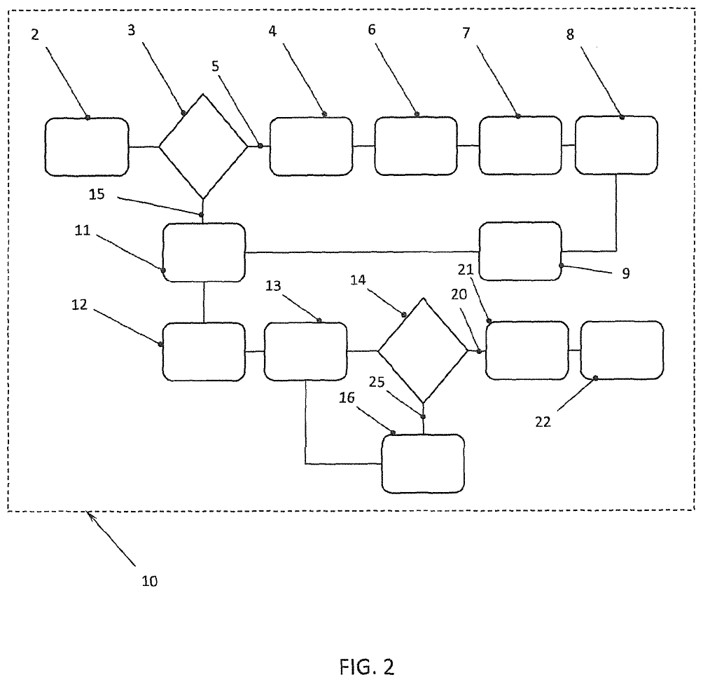

FIG. 2 shows a block diagram of a step of the method according to the present disclosure.

With reference to the Figures, a method 1 for sharing, collecting and processing data, according to the present disclosure, is designed to allow to at least one user to access to a plurality of dedicated structuresd to sports activities and to the physical well-being of the users, such as, for example, gymnasiums, swimming pools, fitness centers, or other similar ones, distributed nationally and internationally, enabling the payment by the user depending on the stay time of the user inside each structure, and on the actual usage time of a plurality of services, such as, for example, fitness activities, body care activities, beauty care activities, etc. provided by the plurality of structures.

In particular, a user, through such method 1, can locate one or more structures located near the user, and use, through a timing, a plurality of sports and well-being services provided by one or more structures located by the user, and advantageously the user will pay only the actual use of the plurality of services related to his stay and usage time inside the structure.

Advantageously, a money compensation paid by the user is computed through such method 1 depending on the stay and usage time of at least one service by the user, and in particular the computing of the money compensation is characterized by at least one preset maximum value, depending on a preset value of the stay and usage time of the user inside the structure, such as for example 4200 seconds, and in relationship to such value of stay and usage time the computing of the money compensation can be interrupted.

As shown in FIG. 1, the method 1 comprises the steps of:
providing at least one electronic device, such as for example, a computer, an I-phone, etc.;
providing, by at least one supplier, the plurality of services provided by at least one structure, and at least one supplier software application, such as for example a browser, or an app on a fixed or mobile device;
acquiring 10 a plurality of functional prerequisites by the user, comprising the steps of:
   providing 2, by the user, at least one user software application on a fixed or mobile device, such as for example a browser, or an app;
   querying 3 the user by the user software application about a user recordal 6;
   if the reply is negative 5: accessing 4 by the user to the section related to payments;
   recording 6 a plurality of user's personal data, such as for example, name, surname, address, profession, etc.;
   contract making 7 and possibly paying by the user at least one economic amount;
   storing 8 the plurality of data;
   issuing 9 at least one distinctive element of the user, such as, for example, a customized member card, or a ticket, or a booklet, or other similar one, designed to identify the user;
   activating 11 the user software application;
   if the reply is positive 15: activating 11 the user software application, and using an activation web page;
   requesting 12 at least one personal data used ba the user during the step of recording, advantageously a reference telephone number;
   executing a verification process;
   receiving 13 at least one verification code on the user device;
   querying 14 the user by the user software application about the reception of the verification code;
   if the reply is negative 25: sending 16 a second verification code;
   receiving 13 the second verification code on the user device;
   if the reply is positive 20: inserting 21 the verification code by the user on the activation web page;
   recognizing the user; and
   arranging and using 22 for the user a starting web page, designed to provide the user with a plurality of information related to the plurality of structures;
locating and validating 67 by the user user a structure, comprising the steps of:
   querying 23 the user, by the user software application, about the locating of at least one structure by the user;
   if the reply is negative 30, the user has not located a structure to which to access;
   querying 24 the user, by the user software application, to locate the structure;
   if the reply is positive 40, arranging and using 26 a web page designed to show the user a plurality of dedicated structures depending on the location of the structures near the user, on the plurality and type of provided services, and on the tariffs of such provided services;
   if the reply is negative 45, arranging and using 27 a web page designed to show the user a plurality of dedicated structures depending on the plurality and type of provided services, and on the tariffs of such provided services;
   locating and validating 28 a structure to which to access;
   if the reply is positive 35, locating and validating 28 a structure to which to access;
using 29 a web page designed to show the plurality of services and of tariffs provided by the structure validated by the user;
validating 31 the structure through a dedicated key;
physically accessing 32 the structure by the user, validating and recognizing, by the user software application, the structure validated by the user, through location, or through the reading of a bi-dimensional bar code, such as, for example a QRcode physically arranged inside the structure validated by the user, etc.;
activating and using 68 the service provided by the structure validated by the user:
   starting a request 33 of the usage of the plurality of services provided by the structure validated by the user, through interaction with a graphic portion, such as for example, a digital start key, or other similar one, of a web page designed to start the usage;
   sending 34, by the user software application, to at least one data managing, storing and processing system, advantageously based on cloud-computing technology or other similar one, a starting request 33 for a usage of at least one service, such as, for example, a sports activity, or a fitness activity, or a well-being activity, or other similar one, provided by the structure validated by the user;
   sending 41, by the data managing, storing and processing system, a confirmation of such starting request 33 to the supplier software application of the plurality of services provided by the structure validated by the user;
   querying 42 the supplier, by the supplier software application, about the confirmation of such starting request 33;
   if the reply is negative 50: the supplier does not confirm such starting request 33, after a time interval, preferably 60 seconds, has elapsed; and/or the user cancels the starting request 33;
   possibly sending 34, by the user software application, to at least one data managing, storing and processing system a further starting request 33 of the usage of the plurality of services by the user;
   if the reply is positive 55: the supplier confirms 43 such starting request 33, through interaction with a graphic portion, such as for example, a digital confirmation key, or other similar one, of a web page designed to confirm the starting request 33;
   sending 44, by the data managing, storing and processing system, to the user software application, at least one message of occurred confirmation of such starting request 33;
   arranging and using 46, on the user software application, a web page designed to show to the user said activating and said usage 68 of the service provided by the structure validated by the user;
   possibly requesting to interrupt 47 by the user of the service provided by the structure validated by the user, through interaction with a graphic portion, such as for example, a digital stop key, or other similar one, of the web page designed to show the user the activation of the service provided by the structure validated by the user;
time and money evaluating 69 the length of the usage of the service provided by the structure validated by the user, comprising the steps of:
   querying 48, by the data managing, storing and processing system, about the length of the usage by the user of the service provided by the structure validated by the user;
   if the reply is positive 60, arranging the usage 54 of a web page on the user software application designed to confirm the interruption request 47 of the service provided by the structure validated by the user;
   interrupting 56, by the data managing, storing and processing system, the service, and computing the money compensation depending on the length of the usage of the service by the user;
   if the reply is negative 65, the length of such usage is greater than a preset value, advantageously equal to 4200 seconds, and in addition such value of usage of the computing of the money compensation is interrupted;
   arranging 49 a web page on the user software application designed to warn the user that such interruption request 47 is waiting for confirmation;
   sending 51 such interruption request 47, by the user software application to the data managing, storing and processing system;
   sending 52 such interruption request 47, by the data managing, storing and processing system to the supplier software application;
   querying 53 the supplier, by the supplier software application, about the confirmation of such interruption request 47;
   if the reply is negative 70: the supplier does not confirm such interruption request 47, after a time interval, preferably of 60 seconds, has elapsed; and/or the user cancels the interruption request 47;
   possibly sending 58 by the user software application to the data managing, storing and processing system, a further interruption request 47 of the usage of the service provided by the structure validated by the user;
   if the reply is positive 75: the supplier confirms 57 such interruption request 47, through interaction with a graphic portion, such as for example, a digital confirmation key, or other similar one, of a web page designed to confirm the request, and sending, by the data managing, storing and processing system to the user software application, at least one message of occurred confirmation of such interruption request 47;
   querying 59 the user, by the user software application, about the reception of the message of occurred confirmation of such interruption request 47;
   if the reply is negative 80, the user has not received the message of occurred confirmation of such interruption request 47, possibly sending 58, by the user software application to a data managing, storing and processing system, an interruption request 47 of the usage of the service by the user;
   if the reply is positive 85, the user has received the message of occurred confirmation of such interruption request 47, interrupting 56 the service, by the data managing, storing and processing system; computing the money compensation depending on the length of the usage of the service by the user; and debiting the money compensation through at least one payment mode inserted by the user when acquiring 10 the plurality of functional prerequisites by the user;
   concluding and paying 71 the usage of the service provided by the structure validated by the user:
   querying 72, by the data managing, storing and processing system, about the correct conclusion of a payment of the money compensation by the user;
   if the reply is positive 90, sending 61, by the data managing, storing and processing system, a communication, through email, or sms, or mms, or other similar one, to the user related to the concluded payment;
   arranging and using 62 a web page on the user software application designed to confirm the correct conclusion of the service and of the related payment;
   concluding 63 the usage of the service provided by the structure validated by the user;
   if the reply is negative 95, sending 64, by the data managing, storing and processing system to the user, a communication, through email, or sms, or mms, or other similar one, to the user related to the not concluded payment;
   arranging and using 66 a web page on the user software application designed to the communication related to the not correctly concluded payment, and a request for update the payment mode inserted by the user when acquiring 10 the plurality of functional prerequisites by the user; and
   concluding 63 the usage of the service provided by the structure located by the user.

Advantageously, the access method 1 is designed to detect, in the following accesses of the user to the user software applications possible anomalies related to at least one not correctly concluded payment, and comprises the following steps:
accessing by the user to the user software application on the mobile or fixed device;
arranging and using 22 the starting web page by the user;
sending, by the data managing, storing and processing system to the user software application, at least one message related to the not correctly concluded payment;
arranging and using, on the user software application, a web page designed for the communication related the not correctly concluded payment, and a request of update of the payment mode inserted by the user when acquiring 10 the plurality of functional prerequisites by the user.

Finally, the method according to the present disclosure is implemented through a system which substantially comprises:
the data managing, storing and processing system, advantageously based on the cloud-computing technology or other similar one;
processing means, comprising at least one database which stores data related to a plurality of users, to a plurality of structures, and to a plurality of services provided by such plurality of structures;
the user software application and the supplier software application, such as, for example, a browser, or an app on a fixed or mobile device of the user and of the supplier;
at least one operating system, such as Android, BlackBerry OS, iOS, Windows Phone or other suitable one, designed to control the operation of such user software application, and/or supplier software application;
at least one sharing means designed to show, on at least one active profile with public and/or private access of said user, a structure and/or a service provided by the structure; such sharing means are possibly a web platform of social networking, such as for example Twitter®, Facebook®, etc.

1. Method for sharing, collecting and processing data, characterized in that it is designed to allow at least one user to locate a plurality of structures, to exploit at least one service provided by said plurality of structures, and to pay by said user depending on the actual usage time of said service by said user, said method being implemented by at least one data managing, storing and processing system comprising:
at least one electronic device;
at least one software application on said electronic device;
a web page designed to show said plurality of services and related tariffs provided by said structure validated by said user.

2. Method according to claim 1 characterized in that it comprises the steps of:
providing said electronic device;
providing, by at least one supplier, said plurality of services provided by at least one of said plurality of structures, and by at least one supplier software application on said electronic device;
acquiring a plurality of functional prerequisites by said user;
locating and validating said structure by said user;
using said web page designed to show said plurality of services and related tariffs provided by said structure validated by said user;
validating said structure through a dedicated key;
physically accessing by said user to said validated structure and recognizing, by at least one user software application, said structure validated by the user;
activating and using said service provided by said structure validated by said user;
time and money evaluating the length of said usage of said service provided by said structure validated by said user; and
concluding and paying said usage of said service provided by said structure validated by said user.

3. Method according to claim 1, characterized in that said locating and validating by said user of said structure comprises the steps of:
querying said user by said user software application about locating said structure by said user;
if the reply is negative, said user has not located said structure to which to access;
querying said user by said user software application about said location of said structure;
if the reply is positive, arranging and using a web page designed to show to said user a plurality of dedicated structures depending on said location of said plurality of structures next to said user, the plurality and type of provided services, and the tariffs of said provided services;
if the reply is negative, arranging and using a web page designed to show to said user said plurality of dedicated structures depending on the plurality and type of provided services, and the tariffs of said provided services;
locating and validating said structure to which to access; and
if the reply is positive, locating and validating said structure to which to access.

4. Method according to claim 2, characterized in that said step of activating and using said service comprises the steps of:
executing a starting request of said usage of said service provided by said structure validated by the user, through interaction with a graphic portion of a web page designed to start said usage;
sending, by said user software application to at least one data managing, storing and processing system, said starting request of said usage of said service, provided by said structure validated by said user;
sending, by said data managing, storing and processing system, a confirmation of said starting request to said supplier software application of said plurality of services provided by said structure validated by said user;
querying said supplier by said supplier software application about a confirmation of said starting request;
possibly sending by said user software application to at least one data managing, storing and processing system a following starting request of said usage of said service by said user;
if the reply is positive: said supplier confirms said starting request, through interaction with a graphic portion of a web page designed to perform said confirmation of said starting request;
sending, by said data managing, storing and processing system to the user software application, at least one message of occurred confirmation of said starting request;
arranging and using on said user software application a web page designed to show to said user said activation and said usage of said service provided by said structure validated by said user; and
possibly requesting to interrupt by said user of said service provided by said structure validated by said user, through interaction with a graphic portion, of said web page designed to show to said user said activation of said service provided by said structure validated by said user.

5. Method according to claim 2, characterized in that said time and money evaluating comprises the steps of:
querying, by said data managing, storing and processing system, about the length of said usage by said user of said service provided by said structure validated by said user;
if the reply is positive, arranging and using a web page on said user software application designed to confirm an interruption request of said service provided by said structure validated by said user;
interrupting said service by said data managing, storing and processing system, and computing a money compensation depending on said length of said usage of said service by said user;
if the reply is negative, said length of said usage is greater than a preset value;
arranging a web page on said user software application designed to warn said user that said interruption request is waiting for confirmation;
sending said interruption request by said user software application to said data managing, storing and processing system;
sending said interruption request by said data managing, storing and processing system to said supplier software application;
querying said supplier by said supplier software application about the confirmation of said interruption request;
if the reply is negative: said supplier does not confirm said interruption request, after said time interval has elapsed; and/or said user cancels the interruption request;
possibly sending by said user software application to said data managing, storing and processing system a following interruption request of said usage of said service provided by said structure validated by said user;
if the reply is positive: said supplier confirms said interruption request, through interaction with a graphic portion of a web page designed to confirm said request, and sending, by said data managing, storing and processing system to said user software application, at least one message of occurred confirmation of said interruption request;
querying of said user by said user software application about a reception of said message of occurred confirmation of said interruption request;
if the reply is negative, said user has not received said message of occurred confirmation of said interruption request, possibly sending, by the user software application to said data managing, storing and processing system, a following interruption request of said usage of said service by said user; and
if the reply is positive, said user has received said message of occurred confirmation of said interruption request;
interrupting said service by said data managing, storing and processing system, and computing said money compensation depending on said length of said usage of said service by said user; and debiting said money compensation through at least one payment mode inserted by said user during said acquiring of said plurality of functional prerequisites by said user.

6. Method according to claim 5, characterized in that said computing of said money compensation paid by said user has at least one preset maximum value, depending on at least one preset value of said usage time of said user inside said structure, and in addition to said preset value, said computing of said money compensation is interrupted.

7. Method according to claim 1, characterized in that said concluding and paying of said using comprises the steps of:
querying, by said data managing, storing and processing system, about a correct conclusion of a payment of the money compensation by said user;
if said reply is positive, sending, by said data managing, storing and processing system, a communication to said user related to said concluded payment;
arranging and using a web page on said user software application designed to perform said confirmation of said correct conclusion of said service and of a related payment;
concluding said usage of said service provided by said structure validated by said user;
if said reply is negative, sending, by said data managing, storing and processing system to said user, a communication related to said not concluded payment;
arranging and using a web page on the user software application designed to perform the communication related to the not correctly concluded payment, and a request to update said payment mode inserted by the user when acquiring said plurality of functional prerequisites by said user; and
concluding said usage of the service provided by said structure located by said user.

8. Method according to claim 1, characterized in that said acquiring comprises the steps of:
providing by said user said user software application on said fixed or mobile device;
querying said user by said user software application about at least one recordal (6) of said user;
if the reply is negative: accessing by said user to said payment on said recordal of a plurality of personal data of said user;
contract making and possibly paying by said user;
storing said plurality of data;
issuing at least one distinctive element of said user, designed to identify said user;
activating said user software application;
if the reply is positive: activating said user software application, and said usage of an activation web page;
requesting at least one personal data used by said user during said step of recording;
executing at least one verification process;
receiving a first verification code on said device of said user;
querying said user by said user software application about said reception of said verification code;
if the reply is negative: sending a second verification code;
receiving the second verification code said device of said user;
if the reply is positive: inserting said second verification code by said user on said activation web page;
recognizing said user; and
arranging and using for said user a starting web page, designed to provide said user with a plurality of information related to said plurality of structures.

9. Method according to claim 8, characterized in that it is designed to detect, in the following accesses of the user to said user software application, possible anomalies related to at least one not correctly concluded payment, the method further comprising the following steps:
accessing by said user to said user software application;
arranging and using said starting web page by said user;
sending, by said data managing, storing and processing system to said user software application, at least one message related to said not correctly concluded payment; and
arranging and using, on said user software application, a web page designed to perform said communication related to said not correctly concluded payment, and at least one request of update of said payment mode inserted by said user during said acquiring of said plurality of functional prerequisites by said user.

10. System designed to perform a method for sharing, collecting and processing data according to any one of the previous claims, characterized in that the system further comprises:
a data managing, storing and processing system;
a plurality of processing means comprising at least one database which stores a plurality of data related to a plurality of users, to a plurality of structures, and to a plurality of services provided by said plurality of structures;
said user software application and said supplier software application, on a fixed or mobile device of a user and of a supplier respectively;
at least one operating system, designed to control an operation of said user software application, and said supplier software application; and
at least one sharing means designed to show, on at least one active profile with public and/or private access by said user, a structure and/or a service provided by said structure.
